(19) United States
(12) Patent Application Publication
(10) Pub. No.: US 2004/0254962 A1
(43) Pub. Date: Dec. 16, 2004

(54) Data replication for enterprise applications

(76) Inventors: Shoji Kodama, San Jose, CA (US); Kenji Yamagami, Los Gatos, CA (US)

Correspondence Address: SQUIRE, SANDERS & DEMPSEY L.L.P, 600 HANSEN WAY, PALO ALTO, CA, 94304-1043, US

(21) Appl. No.: 10/459,776

(22) Filed: Jun. 12, 2003

(51) Int. Cl. G06F 17/30

(52) U.S. Cl. 707/201

(57) ABSTRACT

Aspects of the invention provide for the selective replication of data between a secondary volume and one or more virtual volumes of a storage device. Aspects enable data to be replicated to the virtual volume(s) at one or more selectable checkpoints, and enable data stored in a secondary volume to be “rolled back” to prior secondary storage data via replication from the virtual volumes. Aspects further enable facilitating of various applications or security, among other aspects.

### REFERENCES TO OTHER APPLICATIONS

This application hereby claims priority to and incorporates by reference co-pending application Ser. No. ______, entitled Method And Apparatus For Managing Replication Volumes, filed on Jun. 12, 2003 by Shoji Kodama and Kenji Yamagami.

### BACKGROUND OF THE INVENTION

1. Field of the Invention

This invention relates generally to computer systems, and more particularly provides a system and methods for data replication.

2. Background

Today's enterprise computing systems, while supporting multiple access requirements, continue to operate in much the same way as their small computing system counterparts. The enterprise computing system of FIG. 1, for example, includes application servers 101, which execute application programs that access data stored in storage 102. Storage 102 includes a disk array that can, for example, be configured as a redundant array of independent disks or “RAID”.

Disk array 102 includes an array controller 121a for conducting application server 112a-c access to data volumes 122, 123a-c stored on storage media 121b in the manner next described. Array controller 121 might also provide for data routing, caching, redundancy, parity checking, and the like, in conjunction with the conducting of such data access.

Array controller 121 more specifically provides for data volume access such that a data volume stored by a data-originating server 111a-c can be used independently by a requesting data-utilizing application server application, e.g. of server 112. Array controller 121 first responds to a request from a data-originating application server 111a by storing original data to an original or “primary” volume. Array controller 121 then responds to an initial application request from a data-utilizing application by copying the original volume data to a “secondary” volume 123; the same secondary volume is then used exclusively by that application to store successive modifications of the data, leaving the primary volume intact for similar use by a different application server application.

Unfortunately, while proliferated, such multiple access configurations can nevertheless become inefficient with regard to special uses of the data.

Conventional data backup applications, for example, provide for producing a restorable backup copy of data from locally-stored data. In system 100, an application server 111 application might produce a database that is stored in primary volume 122a. A backup server, e.g., server 112, might then request the database data for conducting a backup to devices 113 (e.g., a tape backup), causing the data to be copied to secondary volume 123. Since the database might be in use during primary volume copying, however, verifying the secondary volume might be desirable. Unfortunately, the verification may well cause the secondary data to be replaced, causing inconsistencies in the backed up secondary volume data.

In software testing, subject software is to be tested in a test environment according to specified conditions. Here, application servers 101 might depict a development system 111a storing software in primary volume 122a, an environment creator 111b storing a test environment in primary volume 122b, a condition creator 111c storing test conditions in primary volume 122c, and a tester 112 for which array controller 102 copies the software, environment and conditions to secondary volume 123 for use during testing. During testing, successively modified environment data produced by the testing replaces the environment stored in the secondary volume. Thus, if the testing fails, then the potentially voluminous test components unfortunately must be re-loaded from their often remote sources.

In batch processing, a subject dataset is to be modified by successive sub-processes. Here, application servers 101 might depict a database-creating server 111 storing database data in primary volume 122a, and a batch processor 112 for which the database is copied to secondary volume 123. Batch processing then causes the secondary volume data to be successively replaced by each sub-process, such that the data reflects the combined result of all completed processes. Unfortunately, if a sub-process produces an error, then the source data must be re-loaded from its source.

Current configurations conducting these and other applications can also be problematic in that the stored data is accessible by the storing application, and no mechanism provides for checking that the resultant data reflects particular processing rather than mere storage of fabricated end results. Therefore, among still further disadvantages, data integrity cannot be readily assured.

Accordingly, there is a need for systems and methods that enable multiple-accessing of data while avoiding the data re-loading or other disadvantages of conventional systems. There is also a need for systems and methods capable of facilitating applications for which special processing of generated data might be desirable.

### SUMMARY OF THE INVENTION

Aspects of the invention enable multiple accessing of data while avoiding conventional system disadvantages. Aspects also enable the facilitating of applications capable of reusing intermediate data results. Aspects still further enable the archival, restoration, reuse and/or management of data that is intermediately or otherwise produced by various applications to be conducted.

In one aspect, embodiments enable one or more “virtual volumes” to be managed, such that intermediately produced or other application data can be selectively stored or retrieved from one or more virtual volumes, or further, in addition to data stored by primary or secondary volumes. Other aspects enable the managing of virtual volumes to be conducted automatically, e.g., programmatically, with application/user control, or further, for such managing to be conducted by a mass storage, such as a disk array, among still further aspects.

In a replication method example according to the invention, a storage device receives one or more first triggers, and stores source data in a primary storage and resultant data in a corresponding secondary storage. The replicating method also includes replicating, responsively to the triggers, the secondary storage data to one or more corresponding virtual storage dataspaces, thereby enabling the secondary storage to be restored (“rolled back”) to the one or more virtual storage dataspaces.

Advantageously, aspects of the invention enable a timed further storage of secondary storage data that might otherwise be replaced by successive resultant data. Aspects further enable selective storage and retrieval of more than one stored dataset, that can further be accomplished using simple commands or in conjunction with an existing storage device. Other advantages will also become apparent by reference to the following text and figures.

### BRIEF DESCRIPTION OF THE DRAWINGS

FIG. 1 is a flow diagram a prior art data storage example;

FIG. 2 is a flow diagram illustrating an interconnected system employing an exemplary data replication system, according to an embodiment of the invention;

FIG. 3 is a flow diagram illustrating a processing system capable of implementing the data replication system of FIG. 2 or elements thereof, according to an embodiment of the invention;

FIG. 4 is a flow diagram illustrating an exemplary processing system based data replication system, according to an embodiment of the invention;

FIG. 5 is a flow diagram illustrating examples of generalized data replication system operation, according to an embodiment of the invention;

FIG. 6 illustrates a exemplary command configurations for virtual volume commands, according to an embodiment of the invention;

FIG. 7a is a flow diagram illustrating examples of array control and virtual volume inter-operation, according to an embodiment of the invention;

FIG. 7b illustrates a combined virtual volume and security mapping table, according to an embodiment of the invention;

FIG. 7c illustrates an array volume mapping table, according to an embodiment of the invention;

FIG. 8 is a flow diagram illustrating an example of how data replication can be used to facilitate data backup applications, according to an embodiment of the invention;

FIG. 9 is a flow diagram illustrating an example of how data replication can be used to facilitate software development applications, according to an embodiment of the invention;

FIG. 10 is a flow diagram illustrating an example of how data replication can be used to facilitate batch processing applications, according to an embodiment of the invention;

FIG. 11 is a flow diagram illustrating examples of how a data replication enabled storage device can be used to conduct one or more applications, according to an embodiment of the invention;

FIG. 12 is a flowchart illustrating a data backup method, according to an embodiment of the invention;

FIG. 13a is a flowchart illustrating a software versioning method, according to an embodiment of the invention;

FIG. 13b illustrates a software versioning table capable of being produced according to the method of FIG. 13a;

FIG. 14a is a flowchart illustrating an environment versioning method, according to an embodiment of the invention;

FIG. 14b illustrates an environment versioning table capable of being produced according to the method of FIG. 14a;

FIG. 15a is a flowchart illustrating a software testing method, according to an embodiment of the invention;

FIG. 15b illustrates a software testing table capable of being produced according to the method of FIG. 15a;

FIG. 16 is a flowchart illustrating a batch processing method, according to an embodiment of the invention;

FIG. 17a illustrates an exemplary virtual volume manager, according to an embodiment of the invention; and

FIG. 17b illustrates an exemplary array controller, according to an embodiment of the invention.

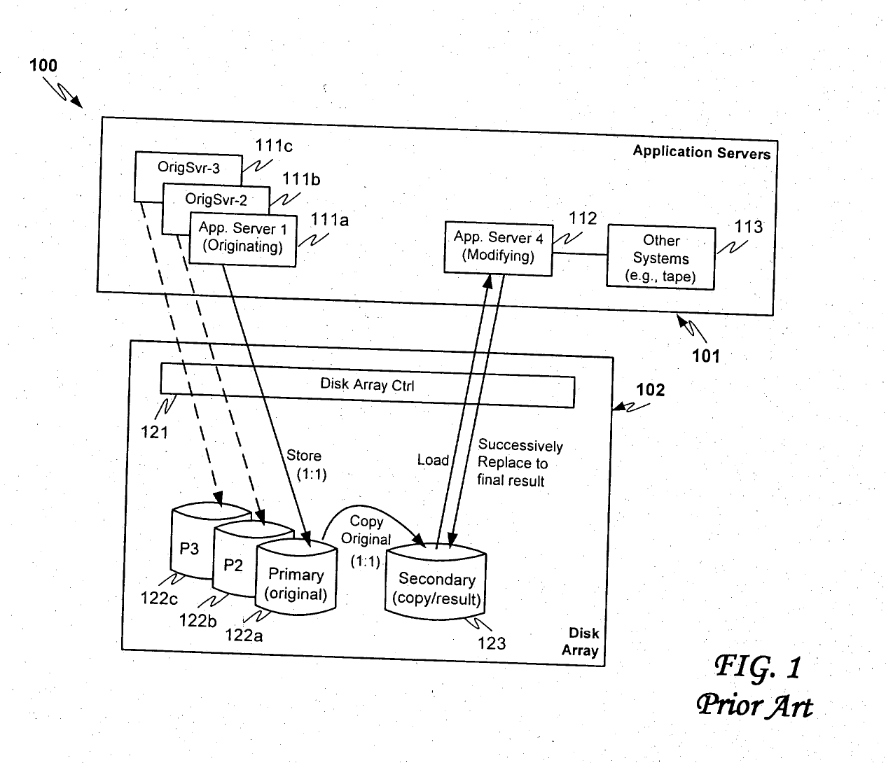

### DETAILED DESCRIPTION

In providing for data replication systems and methods, aspects of the invention enable data, including one or more intermediately produced application data results, to be stored onto a redundant array of independent disks (“RAID”), other disk array or other storage device(s) or storage device configuration(s). Aspects further enable limited or selectable access to the data, re-establishing prior data results, or conducting of security or server-based applications by a storage device, among still further combinable aspects.

Note that the term “or”, as used herein, is intended to generally mean “and/or”, unless otherwise indicated. Reference will also be made to application servers as “originating” or “modifying”, or to replicating, rollback or other system/processing aspects as being applicable to a particular device or device type, so that the invention might be better understood. It will be appreciated, however, that servers or other devices might perform different or multiple operations, or might originate and process originated data. It will further become apparent that aspects might be applicable to a wide variety of devices or device types, among other permutations in accordance with the requirements of a particular implementation. Such terms are not intended to be limiting.

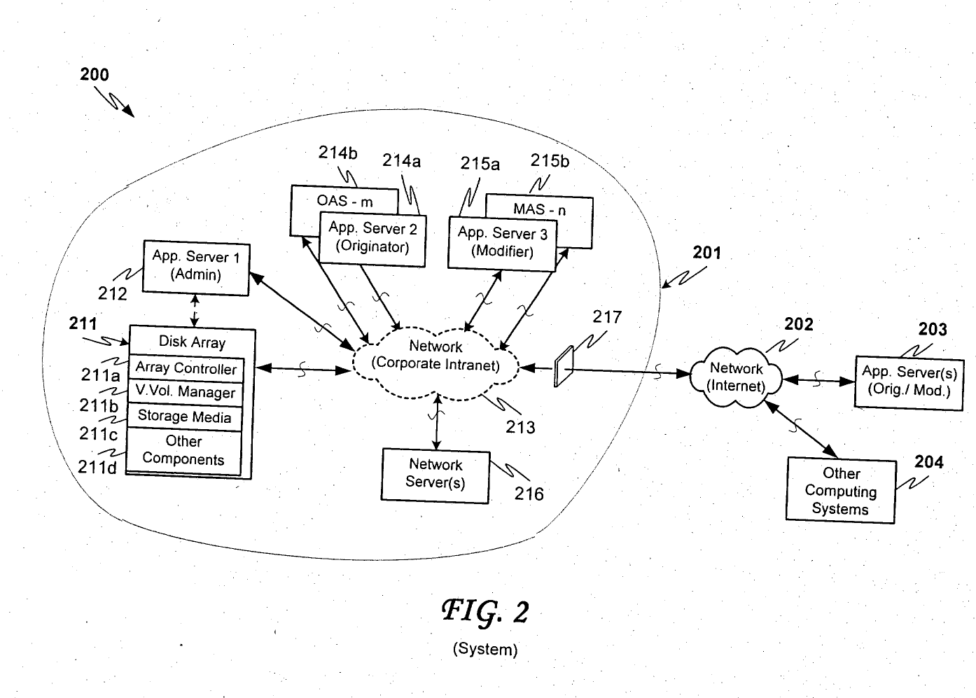

Turning now to FIG. 2, an interconnected system example is illustrated that is configured to provide for data replication in conjunction with one or more computing devices coupled via an interconnected network 201, 202. Replication system 200 includes interconnected devices 201 coupled via intranet 213, including data replication enabled disk array 211, application servers 212, 214a-b, 215a-b and network server 216. System 200 also includes similarly coupled application servers 203 and other computing systems 204, and can further include one or more firewalls (e.g., firewall 217), routers, caches, redundancy/load balancing systems, backup systems or other interconnected network elements (not shown), according to the requirements a particular implementation.

Data replication is conducted in system 200 by a disk array or other shared storage, and more typically a RAID device, such as disk array 211. (Note, however, that a replication-enabled device can more generally comprise one or more unitary or multiple function storage or other devices that are capable of providing for data replication in a manner not inconsistent with the teachings herein.) Disk array 211 includes disk array controller 211a, virtual volume manager 211b and an array of storage media 211c. Disk array 211 can also include other components, 211d such as for enabling caching, redundancy, parity checking, or other storage or support features (not shown) according to a particular implementation. Such components can, for example, include those found in conventional disk arrays or other storage system devices, and can be configured in an otherwise conventional manner, or otherwise according to the requirements of a particular application.

Array controller 211a provides for generally managing disk array operation. Such managing can include, for example communicating with other system 200 devices in conjunction with storage and retrieval of data to/from storage media 211c, or causing such storage, retrieval and support functions to occur. (Array controller 211a components and operation can be provided in an otherwise conventional manner subject to configuration modifications, such as in the examples that follow, or in accordance with a particular implementation.) Array controller 211a support functions can, for example, include creating, maintaining or deleting dataspace references, such as files, folders, directories, volumes, and so on.

Array controller 211a provides for multiple access by creating an “original volume” for storing source or “original” data. Array controller 211a further creates an application dataspace or “secondary volume” for each modifying application server application, and copies thereto data from a corresponding primary volume. Thereafter, array controller 211a receives and stores, in typically the same secondary volume, successive data modifications made and requested for storage by a corresponding application server application. Thus, the original volume remains unaltered and available to other modifying application server applications, the secondary volume contains data reflecting the original data as successively modified and saved by a corresponding application thus far (hereinafter referred to as “resultant data”).

Array controller 211a also provides for management of other disk array components, that can include but are not limited to those already noted. Array controller 211a might further be configured in a more or less integrated manner with or to otherwise inter-operate with virtual volume manager 211b operation to various extents, or virtual volume manager 211b might be configured to operate independently, in accordance with a particular implementation.

In a more integrated configuration, array controller 211a might, for example, provide for passing application server access requests or responses from/to virtual volume manager 211b. Array controller 211a might further provide for command interpretation, or respond to virtual volume manager 211b requests by conducting storage, retrieval or other operations, e.g., operating in a similar manner as with primary/secondary volumes. (It will become apparent that a tradeoff exists in which greater integration of virtual volume management might avoid duplication of more generalized storage device control functionality, while lesser integration might enable greater compatibility with existing storage or host device implementations.)

Virtual volume (“V.Vol”) manager 211b provides for creating, populating, deleting or otherwise managing one or more virtual volumes, or for enabling the selective storing, retrieving or other management of virtual volume data, typically at least within storage media 211c.

Virtual volumes, as with other volume types, provide designations of data storage areas within storage media 211c for storing application data that can be referenced by other system elements. However, unlike primary or secondary volumes, management of virtual volumes also enables one or more “snapshots” of ongoing application data of one or more applications to be selectively stored or retrieved, and for uses other than for merely providing multiple access to the same primary data by different applications. Intermediate as well as original or resultant application data can also be stored in virtual volumes. Virtual volumes can further be managed automatically (e.g., programmatically) or selectively in conjunction with application, user selection or security operations, or otherwise in accordance with a particular application.

Virtual volume manager 211b provides for managing virtual volumes in response to application server application requests or “commands”. Such commands can, for example, be generally configured as with array controller 211a commands, thereby facilitating broader compatibility. Virtual volume manager 211b responds to a more limited set of commands, including those for creating a virtual volume, replicating stored data to a virtual volume, restoring data from a virtual volume, or deleting a virtual volume. It will be appreciated, however, that greater processing capability may enable a broader range of commands or features, only some of which might be specifically referred to herein.

Virtual volume manager 211b can also be configured to communicate more directly with application server applications, or conduct management aspects more indirectly, e.g., via array controller 211a, in accordance with the requirements of a particular implementation. For example, virtual volume manager 211b might, in a more integrated implementation, receive application server commands indirectly via array controller 211a or respond via array controller 211a. Virtual volume manager 211b might also operate more automatically in conjunction with monitoring array controller store, load, or other operations, or provide commands to array controller 211a (e.g., as with an application) for conducting volume creation, data-storing, data-retrieving or other data access operations.

Virtual volume manager 211a might further utilize a cache or other disk array 211 components, though typically in an otherwise conventional manner in conjunction with data access. (It will be appreciated that virtual array controller 211a or virtual volume manager 211b might also be statically or dynamically configurable for providing one or more of such implementation alternatives, or otherwise vary in accordance with a particular application.) Of the remaining disk array 211 components, storage media 211c provides the physical media into which data is stored, and can include one or more of hard disks, rewriteable optical or other removable/non-removable media, cache memory or any other suitable storage media in accordance with a particular application. Other components can, for example, include error checking, caching or other storage or application related components in accordance with a particular application.

Application servers 214a-b, 215a-b, 203, 204 provide for user/system processing within system 200 and can include any devices capable of storing data to storage 211, or further directing or otherwise inter-operating with virtual volume manager 211b in accordance with a particular application. Such devices, for example, might include one or more of workstations, personal computers (“PCs”), handheld computers, settop boxes, personal data assistants (“PDAs”), personal information managers (“PIMs”), cell phones, controllers, so-called “smart” devices or even suitably configured electromechanical devices, among other devices.

Of the remaining system 200 components, networks 213 and 102 can include static or reconfigurable LANs, WANs, virtual networks (e.g., VPNs), or other interconnections in accordance with a particular application. Network server(s) 216 can further comprise one or more application servers configured in an otherwise conventional manner for network server operation (e.g., for conducting network access, email, system administration, and so on), or for operating as a storage device host.

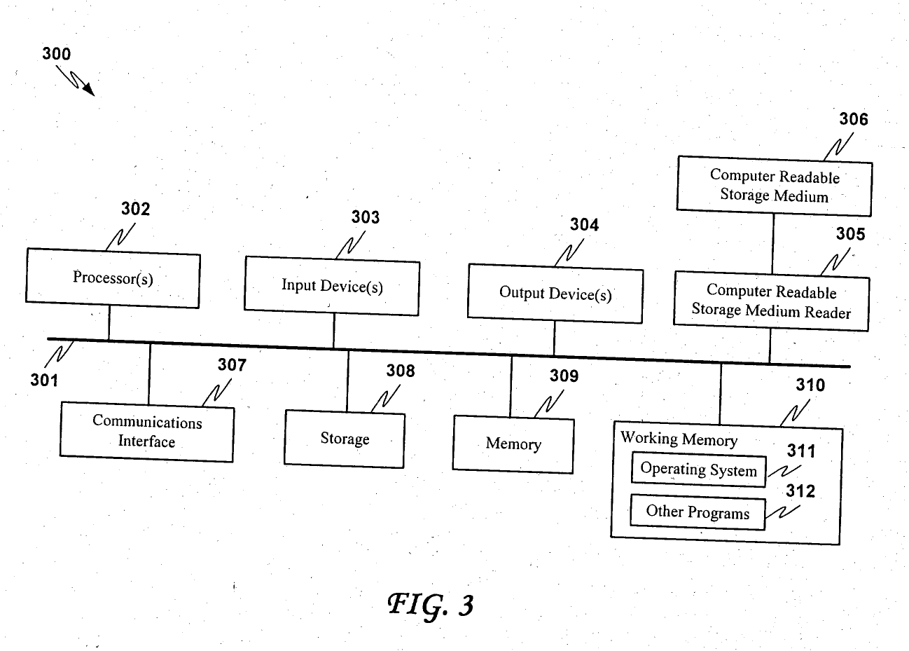

Turning now to FIG. 3, an exemplary processing system is illustrated that can comprise one or more of the elements of system 200 (FIG. 2). While other alternatives might be utilized, it will be presumed for clarity sake that elements of system 200 are implemented in hardware, software or some combination by one or more processing systems consistent therewith, unless otherwise indicated.

Processing system 300 comprises elements coupled via communication channels (e.g., bus 301) including one or more general or special purpose processors 202, such as a Pentium®, Power PC®, digital signal processor (“DSP”), and so on. System 300 elements also include one or more input devices 303 (such as a mouse, keyboard, microphone, pen, etc.), and one or more output devices 304, such as a suitable display, speakers, actuators, etc., in accordance with a particular application.

System 300 also includes a computer readable storage media reader 305 coupled to a computer readable storage medium 306, such as a storage/memory device or hard or removable storage/memory media; such devices or media are further indicated separately as storage device 308 and memory 309, which can include hard disk variants, floppy/compact disk variants, digital versatile disk (“DVD”) variants, smart cards, read only memory, random access memory, cache memory, and so on, in accordance with a particular application. One or more suitable communication devices 307 can also be included, such as a modem, DSL, infrared or other suitable transceiver, etc. for providing inter-device communication directly or via one or more suitable private or public networks that can include but are not limited to those already discussed.

Working memory 310 (e.g. of memory 309) further includes operating system (“OS”) 311 elements and other programs 312, such as application programs, mobile code, data, and so on, for implementing system 200 elements that might be stored or loaded therein during use. The particular OS can vary in accordance with a particular device, features or other aspects according to a particular application (e g. Windows, Mac, Linux, Unix or Palm OS variants, a proprietary OS, and so on). Various programming languages or other tools can also be utilized. It will also be appreciated that working memory 310 contents, broadly given as OS 311 and other programs 312 can vary considerably in accordance with a particular application.

When implemented in software (e.g., as an application program, object, agent, downloadable, servlet, and so on in whole or part), a system 200 element can be communicated transitionally or more persistently from local or remote storage to memory (or cache memory, etc.) for execution, or another suitable mechanism can be utilized, and elements can be implemented in compiled or interpretive form. Input, intermediate or resulting data or functional elements can further reside more transitionally or more persistently in a storage media, cache or other volatile or non-volatile memory, (e.g. storage device 308 or memory 309) in accordance with a particular application.

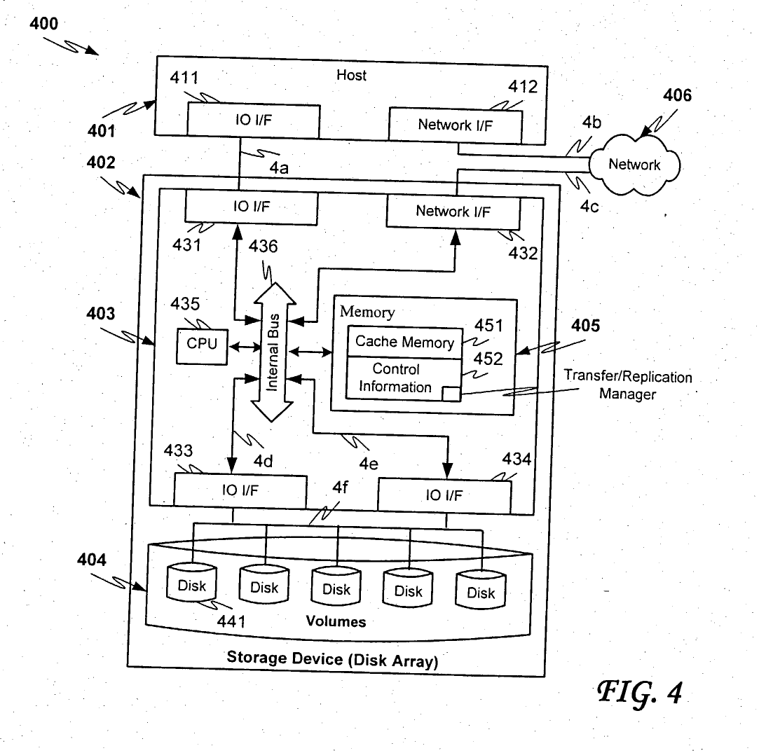

The FIG. 4 example further illustrates how data replication can also be conducted using a replication-enabled storage device (here, a gate array) in conjunction with a dedicated host or other application server. FIG. 4 also shows an example of a more integrated array controller and virtual volume manager combination, i.e., array manager 403. As shown, replication system 400 includes host 401, storage device 402 and network 406. Host 401, which can correspond to system 300 of FIG. 3, has been simplified for greater clarity, while a processor-based storage device implementation (gate array 402), that can also correspond to system 300 of FIG. 3, is shown in greater detail.

Host 401 is coupled and issues requests to storage device 402 via I/O interfaces 411 and 431 respectively, and connection 4a. Connection 4a can, for example, include a small computer system interface (“SCSI”), fiber channel, enterprise system connection (“ESCON”), fiber connectivity (“FICON”) or Ethernet, and interface 411 can be configured to implement one or more protocols, such as one or more of SCSI, iSCSI, ESCON, fiber FICON, among others. Host 401 and storage device 402 are also coupled via respective network interfaces 412 and 432, and connections 4b and 4c, to network 406. Such network coupling can, for example, include implementations of one or more of Fibre Channel, Ethernet, Internet protocol (“IP”), or asynchronous transfer mode (“ATM”) protocols, among others. The network coupling enables host 401 and storage device 402 to communicate via network 406 with other devices coupled to network 406, such as application servers 212, 214a-b, 215a-b, 216, 203 and 204 of FIG. 2. (Interfaces 411, 412, 431, 432, 433 and 434 can, for example, correspond to communications interface 307 of FIG. 3.) Storage device 402 includes, in addition to interfaces 431-434, array manager 403 and storage media 404.

Within array manager 403, CPU 435 operates in conjunction with control information 452 stored in memory 405 and cache memory 451, and via internal bus 436 and the other depicted interconnections for implementing storage control and data replication operations. Cache memory 451 provides for temporarily storing write data sent from host 401 and read data read by host 401. Cache memory 451 also provides for storing pre-fetched data, such as successive read/write requests from host 401.

Storage media 404 is coupled to and communicates with array manager 403 via I/O interfaces 433, 404 and connection 4f. Storage media 404 includes an array of disk drives 441 that can be configured as one or more of RAID, just a bunch of disks (“JBOD”) or other suitable configurations in accordance with a particular application. Storage media 404 is more specifically coupled via internal bus 436 and connections 4d-f to CPU 435, which CPU conducts management of portions of the disks as volumes (e.g., primary, secondary and virtual volumes), and enables host/application server 401 access to storage media via referenced volumes only (e.g., and not by direct addressing of the physical media). CPU 435 can further conduct the aforementioned security, applications or aspects or other features in accordance with a particular implementation.

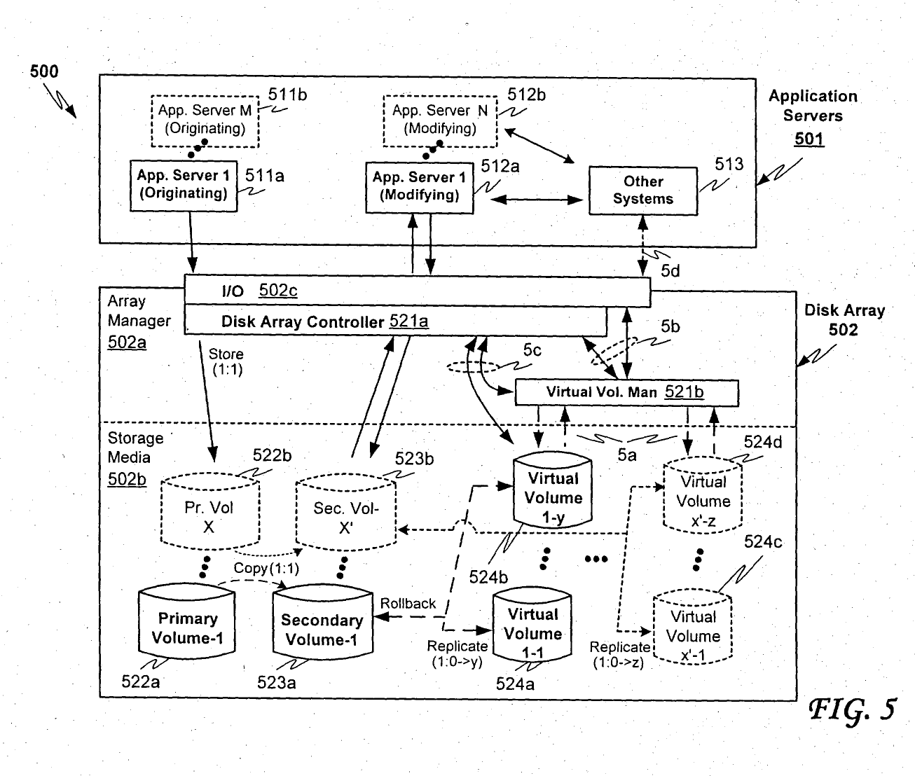

The FIG. 5 flow diagram illustrates a data replication system example in accordance with operational characteristics for facilitating enterprise or other applications in general. System 500 includes application servers 501, and disk array 502. Application servers 501 further include originating application servers 511a-b, modifying application servers 512a-b and other devices 513, and disk array 502 further includes array manager 502a, storage media 502b and network or input output interface, (“I/O”) 502c (which can, for example, correspond with interfaces 431, 432 of FIG. 4). Array manager 502a includes disk array controller 521a and virtual volume manager 521b, while storage media 502b includes one or more each of primary volumes 522a-522b, secondary volumes 523a-522b and virtual volumes 524a-b and 524c-d.

For greater clarity, signal paths within system 500 are indicated with a solid arrow, while potential data movement between components is depicted by dashed or dotted arrows. Additionally, application servers 501, for purposes of the present example, exclusively provide for either supplying original data for use by other servers (originating application servers 1-M 511a, 511b) or utilizing data supplied by other application servers (modifying application servers 1-n 512a, 512b). Each of application servers 511a-b, 512a-b communicates data access requests or “commands” via I/O 502c to array manager 502a.

Originating application server 511a-b applications issue data storage commands to array controller 521a, causing array controller 521a to create a primary volume, e.g., 522a, if not yet created, and storing therein the included original data. Modifying application server 512a-b applications issue data retrieval commands to array controller 521a, causing array controller 521a to return to the requesting application server the requested data, via I/O 502c. Modifying application server applications can also issue data storage commands, causing array controller 521a to create a secondary volume, e.g., 523a, if not yet created, and replacing the data stored therein, if any, with the included resultant data. (For purposes of the present example, only one primary volume might be created for a corresponding dataset and only one secondary volume might be created for each application server, as in conventional systems).

Originating application servers 511a-b generally need not communicate with virtual volume manager 521b. Further, the one or more primary volumes 522a-b that might be used generally need not be coupled to virtual volume manager 521b, since primary volume data is also available for access by virtual volume manager 521b, via array controller copying, from the one or more of secondary volumes 523a-b that might be used. Thus, unless a particular need arises in a given implementation, system 500 can be simplified by configuring disk array 502 (or other storage devices that might also be used) without such capability.

Modifying application server 512a-b applications can, in the present example, issue a limited set of virtual volume commands including checkpoint, rollback and virtual volume delete commands.

An application issuing a checkpoint command causes virtual volume manager 521b to create a virtual volume (e.g., virtual volume 1-1, 524a) and to replicate, to the newly created virtual volume, the current data of the secondary volume that corresponds to the requesting application (e.g. secondary volume-1 523a). Further checkpoint commands from the same application would cause virtual volume manager 521b to similarly create further virtual volumes corresponding to the application (e.g., virtual volume 1-y 524b) and to replicate the then current data of the same secondary volume. However, a further checkpoint commands from a different application would cause virtual volume manager 521b to create a virtual volume corresponding to the different application (e.g., virtual volume x′-1) and to replicate the then current data of the secondary volume corresponding to the different application, e.g. secondary volume x′ 523b, to the virtual value.

An application issuing a rollback command causes virtual volume manager 521b to restore, to the secondary volume corresponding to the requesting application (e.g., secondary volume—1523a), the data stored in the virtual volume that is indicated by the command (e.g. virtual volume 1-1 524a). Further rollback commands from the same application would cause virtual volume manager 521b to similarly replace the data of the same secondary volume (e.g., secondary volume—1523a) with the contents of the indicated virtual volume (e.g. virtual volume 1-1 524a), while a further rollback command from a different application would cause virtual volume manager 521b to replace the data of the secondary volume corresponding to the different application (e.g. 523b) with the indicated virtual volume data (e.g., virtual volume x′-z 524d).

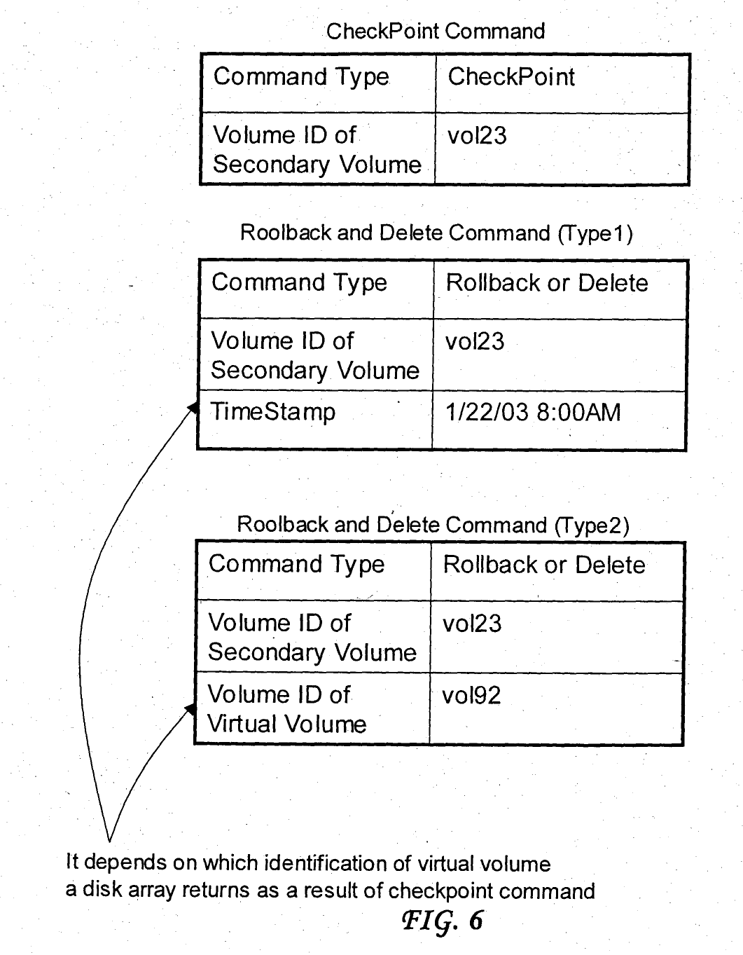

Finally, an application issuing a virtual volume delete command causes virtual volume manager 521b to delete the virtual volume indicated in the command. (Examples of checkpoint, rollback and delete commands are depicted in FIG. 6)

Within array manager 502a, array controller 521a receives and responds to data access store commands from an originating application server 511a-b application by creating a primary volume corresponding to the originating application (e.g., primary volume 522a) if a corresponding primary volume does not already exist, and storing therein the included data. Array controller 521a further responds to a store command from a modifying application server 512a-b application by creating a secondary volume corresponding to the modifying application (e.g. secondary volume 523a) for further use by the modifying application, and storing therein the included data. Array controller 521 also responds to successive store commands from the application by successively replacing the same secondary volume data with the resultant data provided by the application. Array controller 521a responds to retrieve or delete commands from an application server 501 application by respectively returning to the application server the corresponding primary or secondary volume data of the volume indicated in the command, or by deleting the corresponding primary or secondary volume indicated in the command.

Array controller 521a, in the present configuration, receives but disregards virtual volume commands received from application servers 501. Array controller 521a does, however, receive and respond to data access commands from virtual volume manager 521b via interconnections 5b or 5c.

More specifically, virtual volume manager 521b responds to a checkpoint command by determining a corresponding secondary volume and assigning a virtual volume designation corresponding to the command-issuing application server application, and storing the command-issuing application and volume correspondence and assignment for further use. Virtual volume manager 521b also determines and assigns to the virtual volume a time (and date) stamp indicator, and stores the time stamp indicator with the correspondence information, again for further use. Such further use can include, for example, a further rollback or delete volume command by the same application or in assigning a further virtual volume for the same or another application server application.

Virtual volume manager 521b further issues a copy command to array controller 521a including the secondary volume (e.g. secondary volume-I 523a) as the source of the copying and the virtual volume (e.g. virtual volume 1-1 524a) as the destination of the copying. (It will be appreciated that a similar result could also be achieved, for example, by virtual volume manager 521b issuing to array controller 521a a data retrieve command indicating the same source and a store command indicating the same destination.)

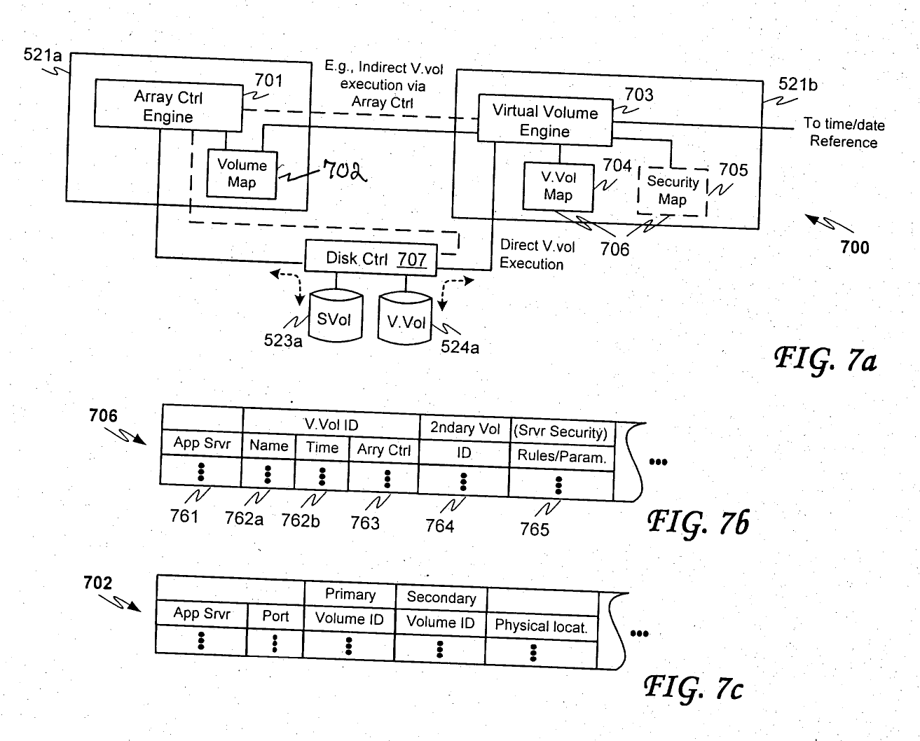

Array controller 521a responds to the copy command in much the same manner as with receiving the above retrieve and store command sequence or copy command as if issued by an application server application, treating the virtual volume as a further secondary volume. That is, array controller 521a first issues a pair-split request to a disk controller (e.g., see FIG. 7a), thus preventing updating of the secondary volume with any new primary volume data while the secondary volume is being accessed by array controller 521a. Array controller then creates the new virtual volume as a secondary volume (e.g., virtual volume 1-1 524a), conducts the copying of the secondary volume data to the virtual volume, and issues a synchronization request to again link the corresponding primary volume with the secondary volume.

Virtual volume manager 521b responds to a rollback command by determining a secondary volume and a virtual volume corresponding to the command-issuing application server application. In this example, the secondary volume is again unknown by reference to the command. Further, while a virtual volume indicator is provided by the command, the indicator may be a time/date indicator or an ID that will not be recognized by array controller 521a. Therefore, virtual volume manager 521b determines secondary volume and virtual volume corresponding references used by array controller 521a by reference to the indicators stored secondary volume during a prior checkpoint command.

Virtual volume manager 521b further issues a copy command to array controller 521a including the determined virtual volume reference (e.g. to virtual volume 1-1 524a) as the source of the copying and the secondary volume (e.g. secondary volume-1 523a) as the destination of the copying. (Note that a similar result could also be achieved for example, by virtual volume manager 521b issuing to array controller 521a a data retrieve command indicating the same source followed by a store command indicating the same destination.) Array controller 521a again responds to the copy command in much the same manner as with receiving the above retrieve and store command sequence or copy command as if issued by an application server application, treating the virtual volume as a further secondary volume. That is, array controller 521a first issues a pair-split request, which prevents updating of the secondary volume with any new primary volume data while the secondary volume is being accessed by array controller 521a. (Array controller 521a does not need to create a volume since both the secondary and virtual volumes already exist.) Array controller 521a then conducts the copying of the virtual volume data to the secondary volume, and issues a synchronization request to again link the corresponding primary volume with the secondary volume.

Virtual volume manager 521b responds to a delete virtual volume command by determining a virtual volume corresponding to the command-issuing application server application. In this case, a virtual volume indicator provided by the command might again be a time/date indicator or a ID assigned by a virtual volume manager that will not be recognized by array controller 521a. Therefore, virtual volume manager 521b determines the corresponding “secondary volume” reference used by array controller 521a by reference to the indicator stored during a prior checkpoint command (e.g., see FIGS. 7a-7c).

Virtual volume manager 521b further issues a delete (secondary volume) command to array controller 521a including the virtual volume (e.g. virtual volume 1-1 524a) as the (secondary) volume to be deleted. Array controller 521a responds to the delete command as if issued by an application server application, treating the virtual volume as a further secondary volume. That is, array controller 521a may first issue a split-pair request, which would prevent attempted updating of the secondary volume with any new primary volume data. Array controller 521a again does not need to create a volume, and proceeds with conducting the deleting of the virtual volume indicated by the delete command from virtual volume manager 521b.

Note that a similar result could also be achieved in a less integrated implementation, for example, by reserving a dataspace within storage media 502b for virtual volumes and configuring virtual volume manager 521b to conduct the copying or deleting operations directly. For example, virtual volume manager 521b might respond to a checkpoint command by determining a corresponding secondary volume and assigning a virtual volume name designation, time stamp or other indicator corresponding to the command-issuing application server application and time/date or other information, storing the command-issuing application and volume correspondence and assignments.

Virtual volume manager 521b might then issue a pair-split command (depending on the implementation) and a copy command indicating the secondary volume (e.g. secondary volume-1 523a) as the source of the copying and the virtual volume (e.g. virtual volume 1-1 524a) as the destination of the copying, and then issue a synchronization command, (e.g., see FIG. 7a), among other alternatives.

Reserving a dataspace might cause storage space to be wasted in a statically assigned dataspace configuration or add complexity in a dynamic dataspace configuration, in which space is allocated as needed. However, such configurations might provide a higher degree of control of virtual volumes by a virtual volume manager, for example, in providing additional features without otherwise impacting array control, such as in providing security that cannot be as easily surmounted via array control. Other features might also be similarly implemented in accordance with a particular application. (While other mechanisms, such as using a shared space for both array control and virtual volume management operations might also be similarly used, the above mechanisms appear to provide similar functionality while imposing less system complexity.)

FIGS. 7a through 7c illustrate examples of the inter-operation of array controller 521a and virtual volume manager 521b in greater detail. Beginning with FIG. 7a, array controller 521a includes array engine 701, which conducts array control operation in conjunction with the mapping of primary and secondary volumes to application servers and physical media provided by multiple-access volume map 702. Virtual volume manager 521b includes virtual volume engine 703, which conducts virtual volume management operation in conjunction with virtual volume map 702, and optionally, further in accordance with security map 705. Virtual volume manager 521b also includes an interconnection 7a to a time and date reference source, which can include any suitable time and date reference.

In each of the checkpoint, rollback and delete commands, virtual volume manager 521b can, for example, determine the corresponding references by building and maintaining virtual volume map 704. Turning also to the exemplary virtual volume (and security) map of FIG. 7b, a mapping of physical media to volumes can be maintained in accordance with a particular array control implementation that includes a correspondence between primary and secondary volumes, and accessing application servers.

Turning further to the exemplary access volume map of FIG. 7c, virtual volume manager 521b (FIG. 7a) can poll the access volume map prior to executing a command (or the basic map can be polled at startup and modifications to the map can be pushed to virtual volume controller, and so on). Virtual volume manager 521b can determine there from secondary volume correspondences, as well as secondary volume assignments made by array controller 521a for referencing virtual volumes (see above). Virtual volume manager 521b can, for example, add such correspondences to map 706 and further add its own virtual volume (ID) assignments to map 706. Virtual volume manager 521b can thus determine secondary volume and virtual volume references as needed by polling such a composite mapping (or alternatively, by reference to both mappings). Other determining/referencing mechanisms can also be used in accordance with a particular implementation such as, for example, that of the above-referenced co-pending application.

FIG. 7b also illustrates an example of how virtual volume manager 521a further enables virtual volume limitations, security or other features to be implemented. A virtual volume manager might, for example implement a limitation on a number of virtual volumes, amount of data that can be stored or other combinable features by polling a virtual volume mapping that includes applicable operational information. Virtual volume map 706, for example, includes application server (applications) 761, as well as corresponding assigned virtual volume reference designations 762a, 762b (e.g., including numerical name and time stamp designations). Virtual volume map 706 also includes array controller references 764 and, in this example, server-specific security parameter rules/parameters 765.

Virtual volume manager 521b can, for example, implement security protocols by comparing an access attempt by an application server, application, user, and so on, to predetermined rules/parameters 765 indicating those access attempts that are or are not allowable by one or more servers, applications, users, and so on. Such access attempts might, for example, include one or more of issuing a rollback or deleting virtual volumes generally or further in accordance with particular data, data types or further more specific characteristics, among other features.

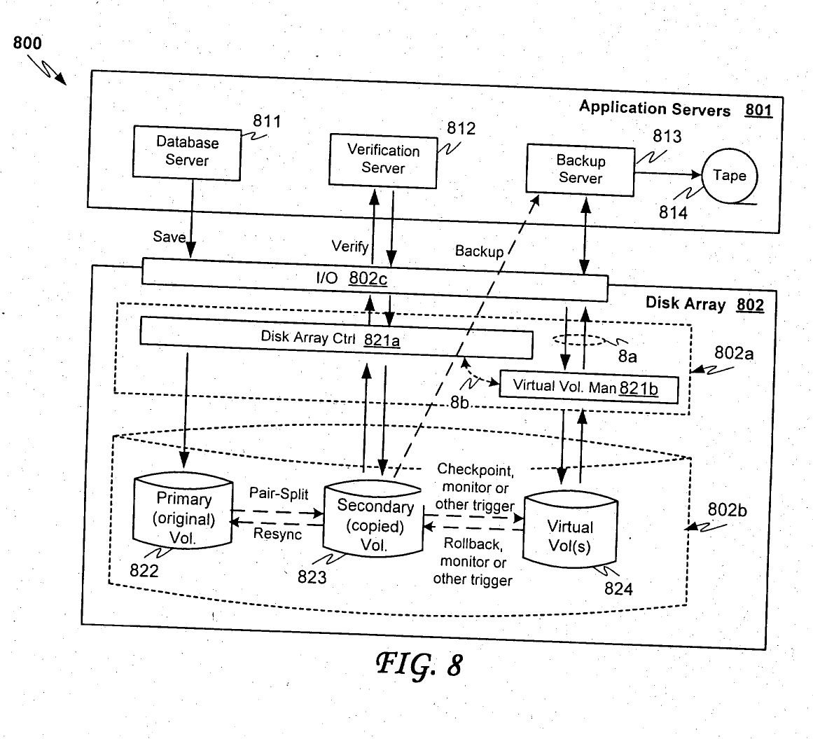

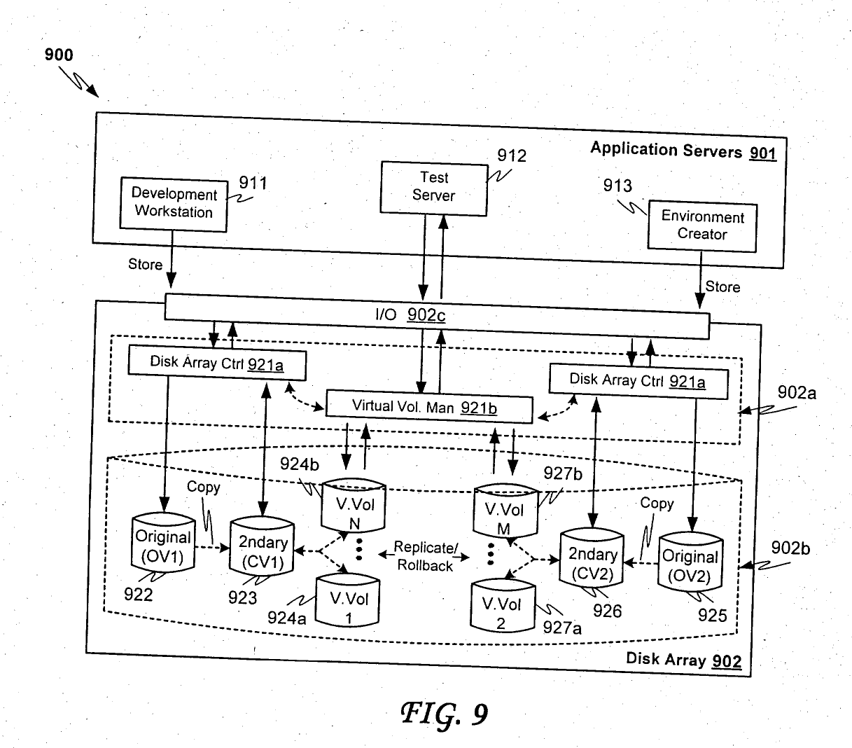

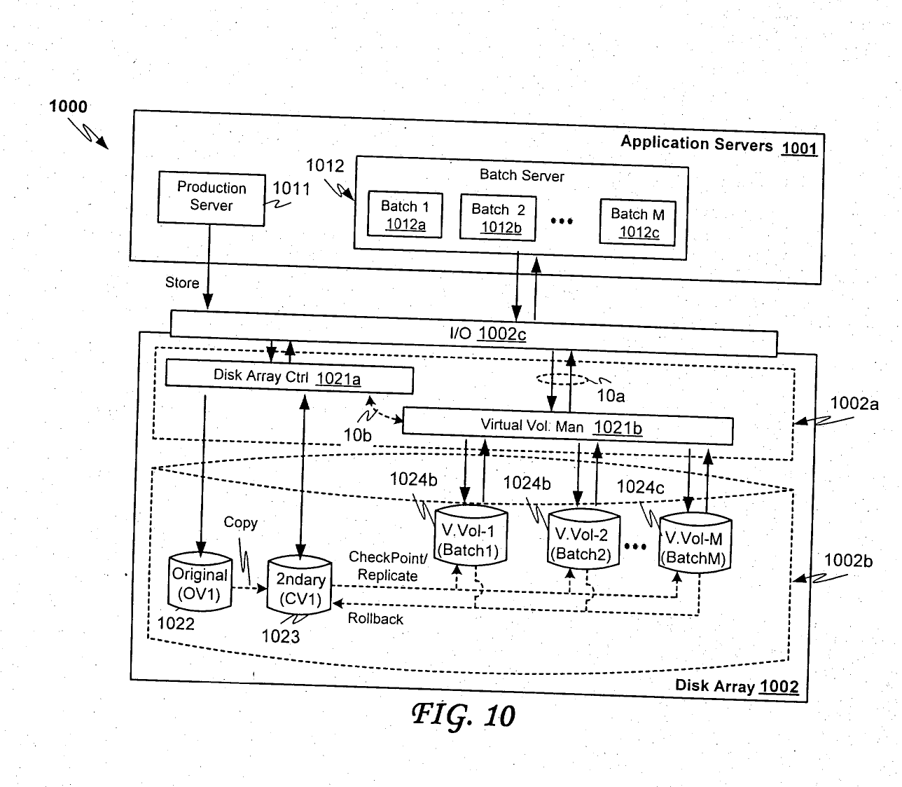

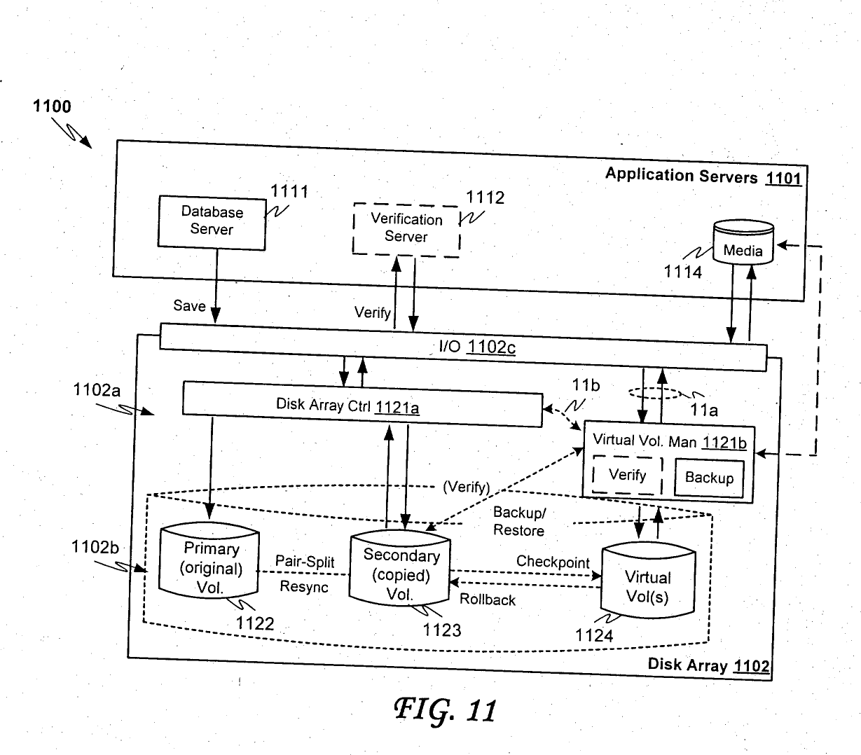

Turning now to FIGS. 8 through 11, data replication can be used to facilitate a wide variety of applications. FIG. 8, for example, illustrates a data backup system, while FIG. 9 illustrates a software development system and FIG. 10 illustrates a batch processing system, each of which is facilitated through the use of data replication. FIG. 11 further provides an example of how data replication can be used to conduct applications or automatic operation. (For consistency, FIG. 11 again uses data backup as an exemplary application.)

Beginning with FIG. 8, it is difficult to assure that a replicated database, i.e., database management system data, or some other subject code or data, in a multiple-access system will be fully updated and consistent. Therefore, it is desirable to verify the database before conducting a data backup of the database. The use of data replication enables verification to be conducted that might alter the subject database as otherwise provided, while still maintaining a reliable database to backup.

In FIG. 8, for example, database server 811 stores a database in original volume 822 that verification server 812 requests for verification. Array controller 821a initiates a pair-split to prevent further synchronization of changes to the database by database server 811 with secondary volume 823 and copies the database to volume 823. A problem in conducting the verification unfortunately still exists, since the verification may alter the secondary volume 823 database and the original volume 822 database might have been updated after the copying. Therefore, no reliable database would remain to be backed up.

However, a reliable database can be provided for backup by replicating the database before it is altered. For example, database server 811 or verification server 812 can initiate replication using checkpoint or other virtual volume replication command prior to a verification server initiated updating of the database in secondary volume 823, causing virtual volume manager 821b to replicate the database to a virtual volume 824. Then, following verification, verification server 812 or backup server 813 can issue a rollback or other virtual volume restore command indicating virtual volume 824 as the source (e.g. using a volume name, timestamp indicator or other ID) causing virtual volume manager 821 to replicate virtual volume 824 to secondary volume 823. Backup server 813 can then conduct a reliable data backup of secondary volume 823, that can further be reliably restored or verified and restored.

Note that virtual volume manager 821 might also automatically (e.g., programmatically) initiate the aforementioned replications. For example, virtual volume manager 821b might monitor, via connections 8a or 8b, the storing to primary volume 822, copying to secondary volume 823 or retrieving or initial storing from/to secondary volume 823 respectively of database server 811, array controller 821 or verification server 812. In such cases, the store, copy, retrieve or other store might serve as a triggering event (such as with a virtual volume command or other triggers), causing virtual volume manager 821 to initiate a replication of secondary volume 823 to virtual volume 824. Alternatively or in conjunction therewith, a data retrieval command issued by backup server 813 might similarly trigger a restore replication by virtual volume manager 821b from virtual volume 824 to secondary volume 823. (It will be appreciated that various triggers might also be used in combination, e.g., one or more of command, singular non-command event, timed or other repeated triggers and so on.)

Continuing with FIG. 9, software development raises the problems of managing versions of the software and testing of the software in various environments or according to varying conditions. During testing of the software, for example, software errors or “bugs” might be identified, causing the software to be modified to a new version that might also require testing. Unfortunately, testing of the prior software version might have changed the environment. Worse yet, bugs might also exist with regard to the environment or conditions, requiring modification and re-testing, or testing of the software using more than one environment or set of conditions might be desirable.

In FIG. 9, for example, development workstation 911 stores software in original volume 922 that verification server 812 requests for verification in conjunction with one or more environments or conditions stored by environment creator 913 in original volume(s) 925. Array controller 821a copies the software and environment plus conditions respectively to secondary volumes 923 and 926. A problem in conducting the software testing unfortunately still exists, since testing would replace the environment of secondary volume 926 and, assuming bugs are found and modifications made, one or more of secondary volumes 923, 926 might also result, interfering with further testing.

However, such testing can be facilitated by replicating the software or environment prior to their modification. For example, environment creator 913 or test server 912 can initiate replication using checkpoint or other virtual volume replication command prior to a test server initiated updating of the environment in secondary volumes 926, causing virtual volume manager 921b to replicate the respective environments to corresponding ones of virtual volumes 927a through 927b. Then, following testing using an environment, test server 912 can issue a rollback or other virtual volume restore command indicating at least one of the virtual volume 927a-b as the source and causing virtual volume manager 921b to replicate the respective virtual volume(s) to secondary volume(s) 926. Testing can then be repeated without a need to again transfer the environment to

Note that, as with data backup, virtual volume manager 821 might also automatically initiate the aforementioned software development replications. For example, virtual volume manager 821b might monitor, via the I/O or array controller connections, the storing to primary volume(s) 925, copying to secondary volume(s) 926 or retrieving or initial storing from/to secondary volume(s) 927a, 927b. In such cases, the store, copy, retrieve or other store might serve as a triggering event, causing virtual volume manager 921b to initiate a replication of secondary volume(s) 926 to virtual volume(s) 927a, 927b. Alternatively or in conjunction therewith, a data retrieval command issued by test server 912 might similarly trigger a restore replication by virtual volume manager 921b from virtual volume(s) 927a, 927b to secondary volume(s) 926 (or various triggers might again be used in combination).

Note also that data replication further utilizing the aforementioned security might be advantageous. For example, by disallowing deletion or modification of an environment by one or more servers or users, a verifiable record can be preserved of the software version, environment, parameters or other operational information (e.g., test administration, user, facility, and so on). A further (secure) backup of such information might then be conducted such that the information backed up might be deleted and storage space freed. (Once again, the backup might also be in conjunction with an external control or automatically conducted in accordance with testing, timed backup, amount of data, and so on. See, for example, FIGS. 7a-c, 9.)

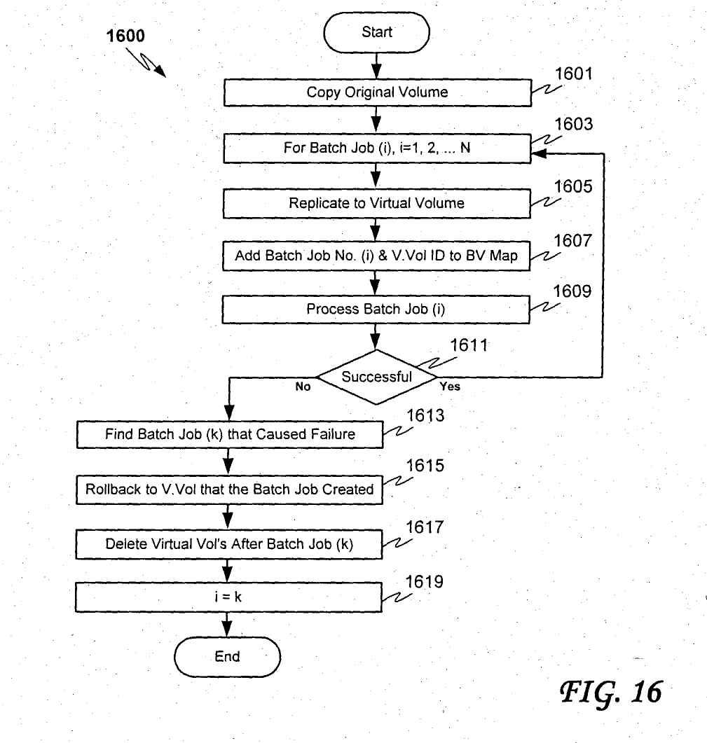

It will still further be appreciated that particularly automatic operation involving different applications might be desirable. As will become apparent, static or dynamic configuration of data replication can also be provided. (See, for example, FIG. 16.

Continuing with FIG. 10, in batch processing a set of sub-processes is conducted in a sequence to produce a final result, with each sub-process using the prior resultant data as source data to be further processed. A problem unfortunately arises in that a misoperation or other “error” during some intermediate sub-process would ordinarily require a re-starting of the entire batch process. To make matters worse, more complex batch processing, more sub-processing or greater amounts of data can not only increase the likelihood of a misoperation, but also increase the time or cost involved in re-starting as well as re-loading of the data, particularly voluminous data or data from a remote site. (A similar problem also arises where different batch processing might be conducted on a database of source data.)

FIG. 10, however, shows an example of how data replication can be used to avoid problems otherwise encountered in batch processing. As shown, production server 1011 stores a database in original volume 1022 that batch server 1012 requests for batch processing. Array controller 1021a copies the database to secondary volume 1023. Batch processor 1012 can initiate replication using a checkpoint or other virtual volume replication command prior to a batch sub-process initiated updating causing the original or resultant data of the prior sub-process to be stored in a respective one of secondary volumes 1024a-c, causing virtual volume manager 921b to replicate the respective resultant data of the sub-process to the virtual volume (e.g., 1024a). Then, following a sub-process disoperation or upon further batch processing and discovery of the misoperation, batch server 1012 can issue a rollback or other virtual volume restore command indicating at least one of the virtual volume 1024a-c as the source, and causing virtual volume manager 921b to replicate the respective virtual volume(s) to secondary volumes 1023. (Typically, only the resultant data immediately prior to the misoperation will be restored, while all batch processes from the misoperation to completion will be deleted. However, the various results might also be used to identify the misoperation or for other purposes.) Batch processing can then be re-started from the process causing the misoperation without a need to re-start the entire batch processing.

Note that, as with the prior applications, virtual volume manager 1021b might also automatically initiate the aforementioned batch processing replications. For example, virtual volume manager 821b might monitor, via the I/O or array controller connections, the storing to secondary volume 1023 which might serve as triggering events, causing virtual volume manager 1021b to initiate a replication of corresponding secondary volume to a respective one of virtual volume(s) 1024a-c. Alternatively or in conjunction therewith, a data retrieval command issued by batch server 1012 might similarly trigger a restore replication by virtual volume manager 1021b (or various triggers might again be used in combination). Security/backup or other operation might also, again, be implemented (e.g., see FIGS. 8 and 9).

FIG. 11 further illustrates how data replication can be used to achieve the above or other advantages while further enabling the application to be conducted by a storage device, here a further disk array. In this example, either one or both of verification and backup server operation can be implemented by virtual volume manager 1121b. For example, database server 1111 and verification server 1112 can operate in conjunction with disk array controller 1121a and virtual volume manager 1121b as discussed with regard to database server 811 and verification server 812 of FIG. 8. Verification server 1112 can then trigger virtual volume manager 1121b or virtual volume manager 1121b can initiate and conduct the backing up of either restored secondary volume data 1123, or further of virtual volume data 1124 automatically or upon a command trigger, thereby avoiding the need to restore the now-verified replicated virtual volume data to secondary storage 1123.

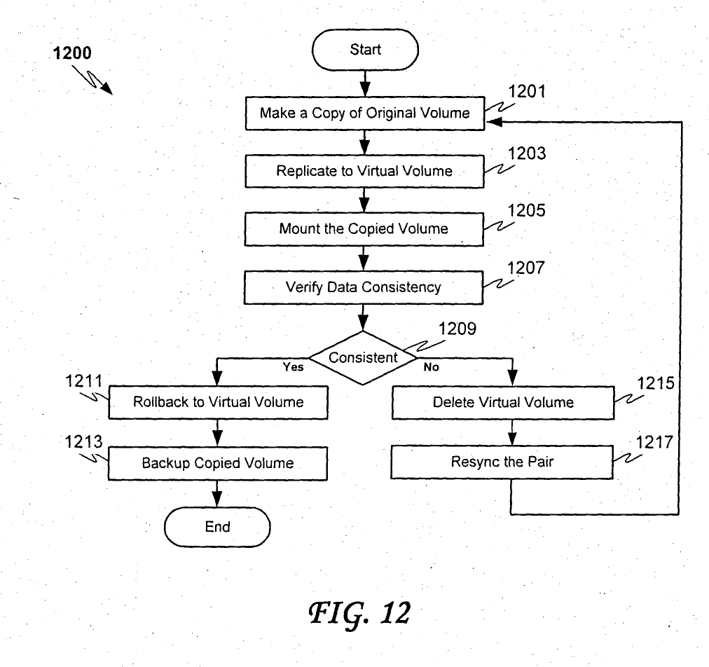

FIGS. 12 through 16 further illustrate methods for using data replication to facilitate various applications. Examples of the specific applications of data backup, software development and batch processing will again be used so that aspects of the invention might be better understood. It will be appreciated, however, that a variety of applications can be facilitated in a substantially similar manner in conjunction with data replication in accordance with the invention.

Beginning with FIG. 12, an exemplary data backup method includes making a copy of the original database in step 1201. This enables verification to be conducted on the copy of the database while preserving the original database for use by other applications via similar copying. In step 1203, the database, and typically the copy rather than the original, is replicated to a virtual volume, such that any updating of the original, or modification of the copy as a result of the verification, will still leave a verified virtual volume if the verification shows that the copy is/was reliable or “consistent”. In step 1205, the copy is mounted for verification, and in step 1207, the copy is verified for consistency.

If, in step 1209, the copy is consistent, then a restore replication or “rollback” of the virtual volume data to the copied data storage is conducted in step 1211 and the restored copy is backed up in step 1213. If instead in step 1209, the copy is unreliable or “inconsistent”, then the virtual volume is deleted in step 1215, the copy is re-synchronized with the original database in step 1217 and the method returns to step 1201.

In FIGS. 12a through 15b, exemplary software development, versioning and testing methods are illustrated.

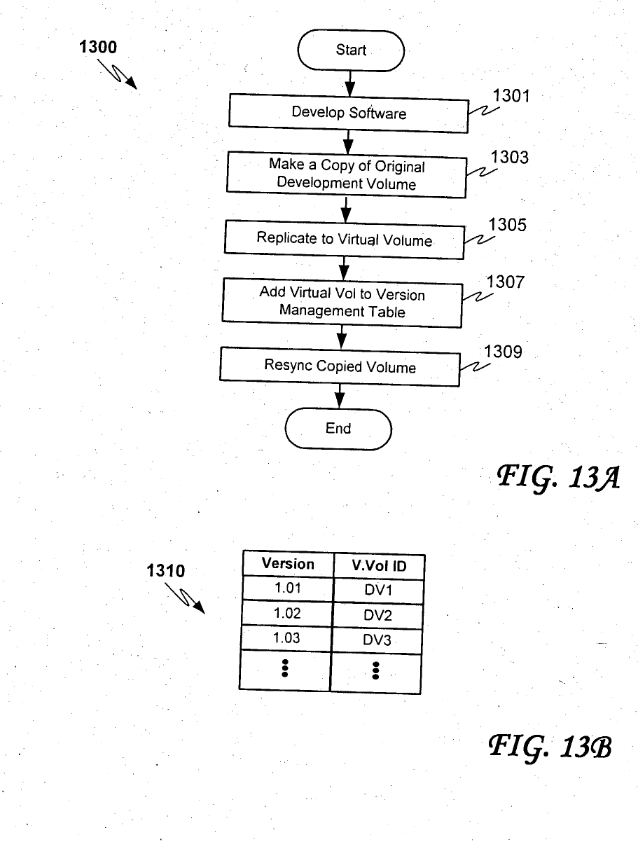

Beginning with FIGS. 13a-b, a software versioning method includes developing software in step 1301 (FIG. 13a). Then, step 1303 includes making a copy of the original software. This enables testing to be conducted on the copy of the software while preserving the original for use by other applications via similar copying, or for otherwise versioning of more than one version of the software, e.g. for testing. In step 1305, the software, and typically the copy rather than the original, is replicated to a virtual volume, such that any updating of the original, or modification of the copy will still leave the virtual volume of the software version intact (e.g., if modification to remove bugs results in a new version). In step 1307, a software version indicator and its corresponding virtual volume ID are added to a software versioning table. Finally, the copy is re-synchronized with a new version of the software, if any, in step 1309. FIG. 13b further shows how a resulting software versioning table includes the software version indicator and its corresponding virtual volume ID (e.g., a name type ID).

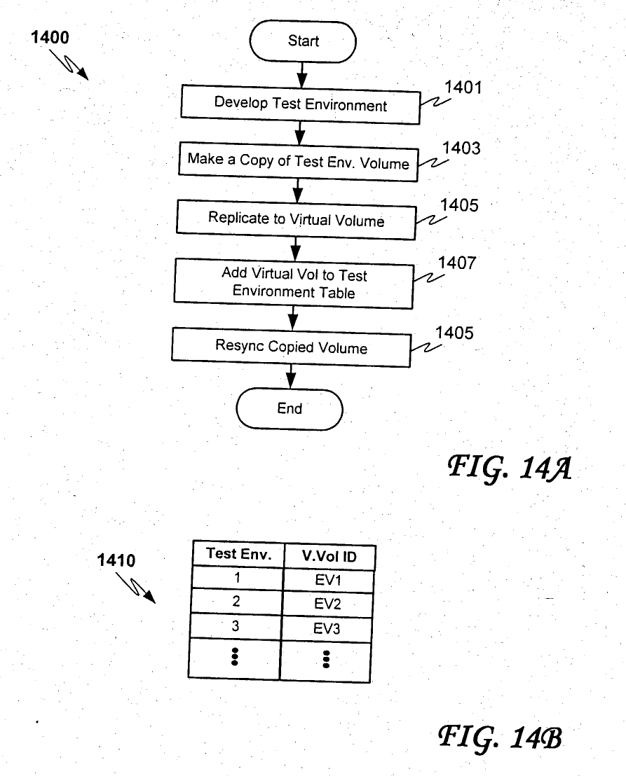

Continuing with FIGS. 14a-b, a test environment versioning method includes developing the test environment in step 1401 (FIG. 14a). Then, step 1403 includes copying the original software. This enables testing to be conducted on the copy of the environment while preserving the original for use by other applications via similar copying, or for otherwise versioning of more than one version of the environment, e.g. for varied software or environment testing. In step 1405, the environment, and typically the copy rather than the original, is replicated to a virtual volume, such that any updating of the original, or modification of the copy will still leave the virtual volume of the environment version intact (e.g., if a modification to remove bugs results in a new version). In step 1407, an environment version indicator and its corresponding virtual volume ID are added to an environment versioning table. Finally, the copy is re-synchronized with a new version of the environment, if any, in step 1309. FIG. 14b further shows how a resulting environment versioning table includes the software version indicator and its corresponding virtual volume ID (e.g., a name type ID).

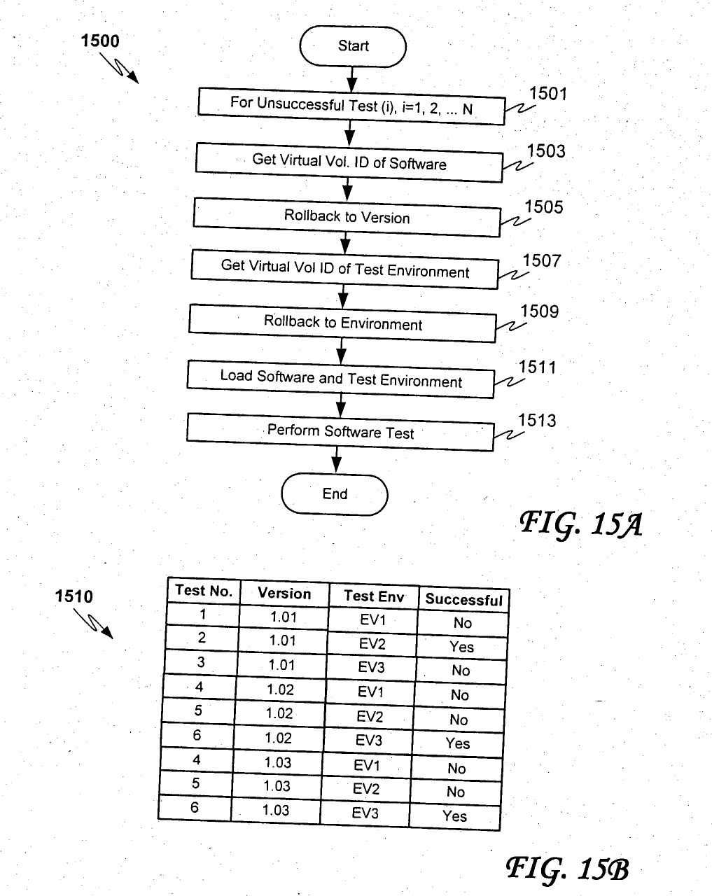

FIG. 15 further illustrates a software testing method operating in conjunction with the prior methods of FIGS. 13 and 14a. As shown, the method includes repeating steps 1503 through 1513 for unsuccessful testing of one to I tests of n software and environment combinations, as given in step 1501. In step 1503, the virtual volume ID of the current software version is retrieved, for example from a software version table, such as that of FIG. 13b. In step 1505, a rollback is conducted from the software version in the copy to the software version stored in a virtual volume. In step 1507, a virtual volume ID of a current environment is further similarly retrieved as the ID corresponding to the environment version found, for example, in an environment table, such as that of FIG. 14b, and a rollback is conducted from the environment version in the copy to the environment version stored in the corresponding virtual volume, in step 1509. Then, the software and test environment copies are loaded in step 1511, and a test of the software running with the environment is conducted in step 1513. (Indicators of the testing results can also be stored, such as with the resulting version-test results table of FIG. 15b.)

FIG. 16 illustrates an exemplary batch processing method including copying an original volume of source data to a secondary volume in step 1601. This enables batch processing to be conducted on the copy of the source data while preserving the original for use by other applications via similar copying. The method further includes repeating steps 1605 through 1619 for one to n batch sub-processes or “batch jobs” of the batch process, as given in step 1603. In step 1605, the secondary volume is replicated to a virtual volume. This enables the source data to be returned to a state prior to a batch job that is unsuccessful, so that processing may be started again with the unsuccessful batch job. In step 1607, the batch job number and corresponding virtual volume ID are added to a batch sub-process or “version” map in step 1607, and the current batch job is processed using the secondary volume copy in step 1609.

If, in step 1611, the current batch job is successful, then the method continues with step 1603. If instead the current batch job is unsuccessful, then, first in step 1613 the unsuccessful batch job is identified, e.g., by reference to the mapping of step 1607 and returning of the corresponding virtual volume ID. Next, a restore replication or “rollback” of the virtual volume given by the returned virtual volume ID to the copied data storage is conducted in step 1615. Next, the virtual volumes created in conjunction with batch jobs after the unsuccessful batch job are deleted in step 1617, and, in step 1619, the current batch job is set to the unsuccessful batch job, for example, to continue the batch processing with the unsuccessful batch job after the cause of the error is corrected.

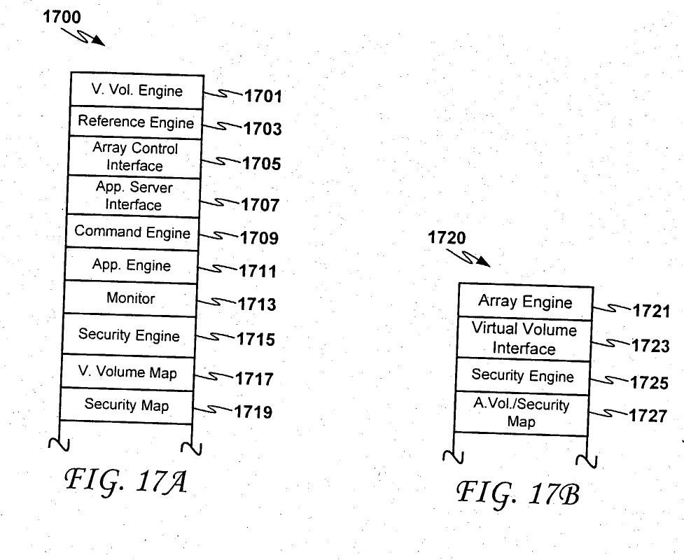

FIGS. 17a and 17b illustrate further examples of a virtual volume manager 1700 and an array controller 1720 respectively.

Beginning with FIG. 17a, virtual volume manager 1700 includes virtual volume engine 1701, reference engine 1703, array control interface 1705, application interface 1707, command engine 1719, application engine 1711, monitor 1713, security engine 1715, virtual volume map 1717 and security map 1719. Virtual volume engine 1701 provides for receiving virtual volume triggers and initiating other virtual volume components. Reference engine 1703 provides for managing virtual volume IDs and other references, e.g., secondary volumes, application servers, applications, users, and so on, as might be utilized in a particular implementation. As discussed, such references might be downloadable, assigned by the reference engine or provided as part of a virtual volume trigger or as stored by an array controller, and might be stored in whole or part in virtual volume map 1719.

Reference engine 1703 also provides for retrieving and determining references, for example, as already discussed. Array control interface 1705 provides for virtual volume manager 1700 interacting with an array controller, for example, in receiving virtual volume commands via or issuing commands to an array controller for conducting data access or support functions (e.g., caching, error correction, and so on). Command engine 1707 provides for interpreting and conducting virtual volume commands (e.g., by initiating reference engine 1703, array control interface 1705, application engine 1711 or security engine 1715.

Application engine 1709 provides for facilitating specific applications in response to external control or as implemented by virtual volume manager 1700. Application engine 1709 might thus also include or interface with a java virtual machine, active-X or other control capability in accordance with a particular implementation (e.g., see above). Such applications might include but are not limited to one or more of data backup, software development or batch processing.

Of the remaining virtual volume components, monitor engine 1713 provides for monitoring storage operations, including one or more of a host device, other application server or array controller. Security engine 1715 provides for conducting security operations, such as permissions or authentication, e.g., see above, in conjunction with security map 1719. Virtual volume map 1717 and security map 1719 provide for storing virtual volume reference and security information respectively, e.g., such as that discussed, in accordance with a particular implementation.

Array controller 1720 (FIG. 17b) includes an array engine 1721 that provides for conducting array control operations, for example, in the manner already discussed. Array controller 1720 also includes virtual volume interface 1723 and security engine 1723. Virtual volume interface 1723 provides for inter-operation with a virtual volume manager, for example, one or more of directing commands to a virtual volume manager, conducting dataspace sharing, interpreting commands or conducting virtual volume caching, error correction or other support functions, and so on. Finally, security engine 1705 operates in conjunction with security map 1707 in a similar manner as with corresponding elements of the virtual volume manager 1700 of FIG. 17a, but with respect to array dataspaces, such as primary and secondary volumes.

While the present invention has been described herein with reference to particular embodiments thereof, a degree of latitude of modification, various changes and substitutions are intended in the foregoing disclosure, and it will be appreciated that in some instances some features of the invention will be employed without corresponding use of other features without departing from the spirit and scope of the invention as set forth.

What is claimed is:

1. A method, comprising:
(a) receiving one or more first triggers by a storage device storing source data in a primary storage and resultant data in a corresponding secondary storage; and
(b) replicating, responsively to the triggers, the secondary storage data to one or more corresponding virtual storage dataspaces, thereby enabling the secondary storage to be restored (“rolled back”) to the one or more virtual storage dataspaces.

2. The method of claim 1, wherein the storage device includes at least one of a disk array and a multiple-access storage device.

3. The method of claim 1, wherein the primary storage, secondary storage and virtual storage dataspaces include a primary volume, a secondary volume and one or more virtual volumes.

4. The method of claim 2, wherein the disk array is configurable as at least one of a redundant array of independent disks (“RAID”) and just a bunch of disks (“JBOD”).

5. The method of claim 1, wherein the one or more triggers include at least one of a data access command corresponding to the primary storage, a data access command corresponding to the secondary storage and a data replication command.

6. The method of claim 5, wherein the data replication command includes a checkpoint command.

7. The method of claim 1, wherein the one or more triggers include a command to initiate an application, the application being conducted, at least in part, by the storage device.

8. The method of claim 7, wherein the application includes at least one of data backup, software testing and batch processing.

9. The method of claim 2, wherein the receiving is conducted, within the storage device, by a virtual volume manager monitoring of commands directed to an array controller.

10. The method of claim 2, wherein the replicating is conducted, within the storage device, by a virtual volume manager causing an array controller to copy the secondary storage data.

11. The method of claim 1, further comprising: receiving, by the storage device, one or more second triggers; and replicating at least one of the virtual storage dataspaces to the secondary storage.

12. The method of claim 1, wherein the replicating stores data to be backed up in conjunction with a data backup application, thereby enabling a verifying of the secondary storage data.

13. The method of claim 1, wherein the replicating stores at least one of a software program and an environment in conjunction with software testing of a software program stored in the secondary storage.

14. The method of claim 1, wherein the replicating stores a resultant data of at least one batch sub-process in conjunction with batch processing of secondary storage data.

15. The method of claim 1, wherein the step (b) of replicating is replaced by: determining whether the indicator indicates a security status sufficient for enabling a corresponding data access; and if so, replicating, responsively to the triggers, the secondary storage data to one or more corresponding virtual storage dataspaces, thereby enabling the secondary storage to be restored (“rolled back”) to the one or more virtual storage dataspaces.

16. A system, comprising:
(a) means for receiving one or more first triggers by a storage device storing source data in a primary storage and resultant data in a corresponding secondary storage; and
(b) means for replicating, responsively to the triggers, the secondary storage data to one or more corresponding virtual storage dataspaces, thereby enabling the secondary storage to be restored (“rolled back”) to the one or more virtual storage dataspaces.

17. The system of claim 16, wherein the storage device includes at least one of a disk array and a multiple-access storage device.

18. The method of claim 16, wherein the primary storage, secondary storage and virtual storage dataspaces include a primary volume, a secondary volume and one or more virtual volumes.

19. The system of claim 16, wherein the one or more triggers include at least one of a data access command corresponding to the primary storage, a data access command corresponding to the secondary storage and a data replication command.

20. The method of claim 19, wherein the data replication command includes a checkpoint command.

21. The system of claim 16, wherein the one or more triggers include a command to initiate an application, the application being conducted, at least in part, by the storage device.

22. The method of claim 17, wherein the means for receiving provide, within the storage device, for receiving by a virtual volume manager monitoring of commands directed to an array controller.

23. The method of claim 18, wherein the means for replicating provide, within the storage device, for a virtual volume manager causing an array controller to copy the secondary storage data.

24. The system of claim 16, further comprising: means for receiving, by the storage device, one or more second triggers; and means for replicating at least one of the virtual storage dataspaces to the secondary storage.

25. The system of claim 16, wherein the means for replicating store data to be backed up in conjunction with a data backup application, thereby enabling a verifying of the secondary storage data.

26. The system of claim 16, wherein the means for replicating stores at least one of a software program and an environment in conjunction with software testing of a software program stored in the secondary storage.

27. The system of claim 16, wherein the means for replicating stores a resultant data of at least one batch sub-process in conjunction with batch processing of secondary storage data.

28. A computer storing program for causing the computer to perform the steps of:
(a) receiving one or more first triggers by a storage device storing source data in a primary storage and resultant data in a corresponding secondary storage; and
(b) replicating, responsively to the triggers, the secondary storage data to one or more corresponding virtual storage dataspaces, thereby enabling the secondary storage to be restored (“rolled back”) to the one or more virtual storage dataspaces.
